(19) United States
(12) Patent Application Publication
(10) Pub. No.: US 2025/0094569 A1
(43) Pub. Date: Mar. 20, 2025

(54) DATA SECURITY MECHANISMS IMPLEMENTED USING MACHINE LEARNING PREDICTORS

(71) Applicant: Microsoft Technology Licensing, LLC, Redmond, WA (US)

(72) Inventors: Jinghua CHEN, Redmond, WA (US); Michael BETSER, Highlands Ranch, CO (US); John WANG, Bellevue, WA (US); Ashish MEHNDI, Hyderabad (IN); Sharath Chandra ABBARAJUVENKATA, Hyderabad (IN); Weisheng LI, Bothell, WA (US)

(21) Appl. No.: 18/394,219

(22) Filed: Dec. 22, 2023

(30) Foreign Application Priority Data
Sep. 14, 2023 (IN) 202311061901

(51) Int. Cl. G06F 21/55

(52) U.S. Cl. CPC G06F 21/552; G06F 2221/034

(57) ABSTRACT

Aspects and embodiments herein pertain to global ML prediction applied in a data security context. In some examples, a global prediction pertaining to a data item as a whole (the ‘original’ data item) is generated using an ML predictor. A data element is masked by removing it from the data item, or obscuring it in some way (e.g., through modification or replacement). The same ML predictor is applied to the perturbed data item. A change in global confidence between the original data item and the perturbed data item denotes local significance of the individual data item (or subset of data items) that have been masked. Other significance indicators (such as start and end markers of significant sections) are also considered. Other methods of estimating local significance are considered. In some examples, one or more such methods are used to generate training data for training a self-interpretation ML model.

### CROSS-REFERENCE TO RELATED APPLICATION

This application claims priority to Indian Provisional Patent Application No. 202311061901, entitled “Data Security Mechanisms Implemented Using Machine Learning Predictors,” filed on Sep. 14, 2023, the disclosure of which is incorporated herein by reference in its entirety.

### TECHNICAL FIELD

The present disclosure pertains to a range of data security mechanisms implemented using machine learning (ML) predictors.

### BACKGROUND

Herein, ‘data security’ refers broadly to mechanisms that prevent or reduce unauthorised actions on electronic data (or information contained in such data), such as specified electronic data (e.g., data explicitly marked as ‘sensitive’ because it is confidential or private in nature, or sensitive in some other respect) or predetermined types of electronic data (e.g., specified ‘sensitive’ data classes, categories etc.). Such mechanisms may, for example, be designed to prevent unauthorized access, release, exchange, modification, destruction, disruption or use of such data in a computer system or electronic data storage system, whether accidental or intentional. Data security includes, for example, mechanisms to prevent unlawful access to specified data or specified data types, prevent deletion or modification of electronic data based on a defined data retention policy, prevent users of the system who are not authorized to access, modify, delete or exchange certain data or certain types of data, prevent the release of certain data or types of data to ‘external’ third-parties (such as third-parties submitting a data request, etc.). Such mechanisms may be automated (e.g., automatically blocking access to certain files, blocking uploads/downloads of certain files, or modifying a version of a document prior to upload or download to redact identified sensitive information). Such mechanisms may alternatively be semi-automated (e.g., certain data elements may be identified automatically as potentially sensitive, and flagged for manual review within a graphical user interface). For example, a third-party might submit a request for certain data held in the system concerning that third-party. Before releasing data in response to the request, there may be a requirement to remove sensitive information (e.g. relating to a different party or parties), which may be identified automatically and removed either automatically or semi-automatically though a guided user-machine interaction.

ML predictors may be used in a data security context to perform tasks such as enforcing data loss prevention policies or other forms of data/information security policies (or assisting a user in enforcing such policies through partial automation). For example, an ML predictor may be used to automatically detect when a data item contains data of a predetermined sensitive type(s). An ML predictor refers to an ML classifier, an ML regression model or other ML prediction model (or a collection of multiple such models), which is (or are) trained in a supervised manner based on one or more training sets, or an unsupervised manner, or via a combination of supervised and unsupervised training. Such models may be confidence-based (e.g., probabilistic), meaning an output(s) is provided with an indication of confidence (e.g., numerical confidence score, such as a floating-point score, or categorical confidence score, such as ‘low’, ‘medium’ or ‘high’). The term ‘prediction’ may be used in this context to refer to a process of generating an output from a given input using an ML predictor.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

Data security applications may utilize ‘local’ or ‘global’ ML predictors, or a combinations of global and local prediction. When applied to a data item, ‘local prediction’ refers to a prediction method or algorithm whose output is localized to individual data elements(s) within the data item. For example, the output of such a model might identify individual data element(s) as sensitive or potentially sensitive, possibly with an indication of confidence in the localized prediction. Examples of local ML predictors include information extraction models which extract relevant data elements from a data item. By contrast, a ‘global’ prediction method or algorithm, given a data item as input, generates a prediction pertaining to the data item as a whole. For example, a given data item might be tagged by an ML predictor as potentially containing sensitive information (perhaps with an overall measure of confidence), without identifying specific individual data element(s) as sensitive in its output.

Aspects and embodiments herein pertain to global ML prediction applied in a data security context. In some examples, a global prediction pertaining to a data item as a whole (the ‘original’ data item) is generated using an ML predictor. The global prediction includes a (numerical or categorical) confidence score (the ‘original’ prediction). In addition, a perturbed data item is generated by masking a data element in the original data item. A data element is masked by removing it from the data item, or obscuring it in some way (e.g., through modification or replacement). The same ML predictor is applied to the perturbed data item, resulting in a further prediction (the ‘perturbed’ prediction), which also includes a global confidence score (the ‘perturbed’ confidence score). Whilst the original and perturbed predictions are global, the perturbation applied or the data item is localized to an individual data element or subset of data elements in the data item. Hence, a change in global confidence between the original data item and the perturbed data item denotes local significance of the individual data item (or subset of data items) that have been masked. Thus, a (localized) significance score may be assigned to the individual data item (or subset of data items) based on the original global confidence score and the perturbed global confidence score. In some embodiments, these operations may be repeated for different data elements/subsets, resulting in multiple significance scores for different individual data elements or different combinations of data elements. The global prediction on the data item and the localized significance score(s) can, in turn, be used to implement various data security tasks, such as tasks of the kind discussed above. Other significance indicators (such as start and end markers of significant sections) are also considered. Other methods of estimating local significance are considered. In some examples, one or more such methods are used to generate training data for training a self-interpretation ML model.

### BRIEF DESCRIPTION OF FIGURES

Illustrative embodiments will now be described in detail, by way of example only, with reference to the following figures, in which:

FIG. 1 shows a schematic example block diagram of a prediction stage and an interpretation stage;

FIG. 2 shows a schematic example view within a graphical user interface (GUI);

FIG. 3 shows a schematic block diagram of a method for training a self-interpretation model.

FIG. 4 shows an example model interpretation output generated through aggregation;

FIG. 5 shows a schematic block diagram of a computer system;

FIG. 6 shows an example cloud-computing deployment scenario; and

FIG. 7 shows a schematic block diagram of an example computer system.

### DETAILED DESCRIPTION

The described embodiments yield improvements in the performance of global ML predictors in comparison to conventional methods. In a data security system employing ML predictors, improved prediction performance has a consequent data security improvement arising from reduced false negative rates (reducing the risk of data security breaches) and/or reduced false positive rates (improving overall system performance by reducing the rate at which data security mechanisms are engaged inappropriately) at runtime.

Global ML predictions methods have various benefits over localised ML prediction methods. One benefit of global ML predictors is that they are significantly easier to train using supervised methods, particularly when large volumes of training data are required. Supervised training requires some form of ‘labelled’ training data. For example, to train a global ML classifier, a training set may be generated by selecting an appropriate range of data items and labelling each data item with a simple global classification label (or labels). These labels serve as ground truth during training. The global ML classifier is architected to generate an output in a comparable form to the training labels. During training, the global ML classifier is repeatedly applied to the training set, and parameters of the global ML classifier are systematically tuned based on a comparison of its outputs with the training labels. Assessing global training labels to the training data is a relatively straightforward labelling task, which can be feasibly carried out even on large volumes of data (using manual, automated, or semi-automated labelling methods). Moreover, it may be possible to implement the ML classification model with a simpler architecture, reflecting the relatively simpler form of its output.

By contrast, local ML prediction methods typically require ‘richer’ training data, and potentially more complex model architectures. For example, a conditional random field model might be trained to assign a relevancy label or score to every individual element of an input data sequence. The training of such models requires training data that has been similarly labelled at the level of individual data elements. For example, it might be necessary to assign a training label to every data element of a training sequence. This is a more burdensome labelling tasks, particular when it has to be repeated over a large training set. Moreover, a more complex model architecture may be required in order to represent localized outputs at the level of individual data elements.

On the other hand, global ML predictors can suffer from issues of ‘explainability’. Depending on model type, it is sometimes challenging to understand why a global ML predictor produced a particular global prediction. This is especially true of ML predictors with neural network architectures (particularly deep neural network architecture). This lack of explainability, in turn, has led to performance issues in conventional ML predictors. When the output of a predictor is not readily explainable, it becomes harder to identify—and, therefore, mitigate—performance issues. Conventional global ML predictors are, therefore, prone to performance issues (such as producing inaccurate or misleading outputs), which are seemingly ‘random’ because they are challenging to predict or diagnose. When used in a data security context, this can have severe implications. For example, if a global classifier in a data security system fails to classify a sensitive data item as sensitive (a ‘false negative’ outcome), then the data security system might wrong permit restricted actions to be performed on the data item (such as deletion, modification, release to an external party etc.). More generally, false negative detections can result in data security breaches because a data security mechanism fails to engage when it should. False positives are also an issue. A false positive might occur in this context when a global ML classifier wrong classifies a non-sensitive data item as sensitive, meaning a data security mechanism is engaged inappropriately. Data security mechanisms are, by their very nature, restrictive, and false positives that result in frequent inappropriate engagement of such can significantly and unnecessarily impact overall system performance.

Embodiments described herein consider a global prediction output pertaining to a data item as a whole (the ‘original’ data item), which is generated using an ML predictor. The global prediction includes a (numerical or categorical) confidence score (the ‘original’ prediction). In addition, a perturbed data item is generated by masking a data element in the original data item. A data element is masked by removing it from the data item, or obscuring it in some way (through modification or replacement). The same ML predictor is applied to the perturbed data item, resulting in a further prediction (the ‘perturbed’ prediction), which also includes a global confidence score (the ‘perturbed’ confidence score). Whilst the original and perturbed predictions are global, the perturbation applied or the data item is localized to an individual data element or subset of data elements in the data item. Hence, a change in global confidence between the original data item and the perturbed data item denotes local significance of the individual data item (or subset of data items) that have been masked. This, a (localized) significance score may be assigned to the individual data item (or subset of data items) based on the original global confidence score and the perturbed global confidence score. In some embodiments, these operations may be repeated for different data elements/subsets, resulting in multiple significance scores for different individual data elements or different combinations of data elements.

Another benefit arises when a predictor is applied to confidential or private data. For example, in one deployment scenario, a provider provides users or user groups (such as customers) with data security mechanisms and predictors trained on ‘open’ data (e.g., public data, or other data that is not specific to e.g., the provider's customers). Customers or other users can then deploy the predictors and data security mechanisms on private data, secured within their own infrastructure. The interpretation techniques can then be applied by each customer to generate feedback to the provider (such as the top N data elements deemed to be important for a given detector, aggregate over multiple data items). This feedback can, in turn, be used by the provider to improve model performance, without the customer ever having to release their underlying private data to the provider.

The global prediction on the data item and the localized significance score(s) can, in turn, be used to implement various data security tasks, such as tasks of the kind discussed above. In certain embodiments, the techniques may be applied in a training, re-training or validation context, in which performance of a global ML predictor is assessed using localized significance(s) score generated in this manner (in addition or as an alternative to assessing performance based on the global prediction), ultimately resulting in improve global detection performance, with consequential improvements in data security mechanisms supported by global ML prediction.

In such implementations, a global ML predictor may be trained or re-trained based on local significance score(s) assigned to individual data elements (or combinations of data elements), for example by using the significance score(s) to identify a performance issue, which in turn is used to generate a modified training set (e.g, by adding, removing or modifying examples from a training set on which the ML predictor has been or is being trained). Significance score(s) may be used to identify and mitigate performance issues in other ways, for example my modifying an architecture of a global ML predictor, or selecting a new prediction model that can achieve better performance.

In certain embodiments, the described techniques are applied in a training, re-training or validation context, in which performance of a global ML predictor is assessed using localized significance(s) score generated in respect of individual data element(s) or particular combination(s) of data elements (in addition or as an alternative to assessing performance based on a global prediction output), ultimately resulting in improve global detection performance, with consequential improvements in data security mechanisms supported by global ML prediction. Hence, in certain embodiments, an ML predictor may be (re-) trained or otherwise modified based on a localized significance score assigned to a data element(s) within a data item. The result is an improved global ML predictor, which yields consequent improvements in data security.

In some embodiments, alternatively or additionally, a first threshold may be applied to a global confidence score, such that a global confidence score above the first threshold (e.g., a confidence score pertaining to a particular information category) triggers a positive detection. Significance scores (or importance scores) may be assigned to individual data element(s) (or combination of data element(s)) using local importance estimation techniques described herein. A second threshold (or thresholds) may, in turn, be applied to the local importance scores, to identify any important data element(s) as those having significance score(s) above the second threshold (or above an applicable second threshold). Various data security actions may in turn be triggered, such as generating a visual alert in response to the positive detection with any important data element(s) visually highlighted, or redacting the important data element(s) from the data item or a version for the data item (e.g., creating a separate upload or download copy of a data item with the important data item(s) redacted) etc. Another application of local importance estimation is training/validation of the global predictor.

The following examples describe an effective global interpretation architecture to identify sensitive data elements (such as ‘keywords’ or key tokens) in a data item (such as a document or other file) by leveraging two layers of ML model inference, namely prediction and interpretation. The interpretation stage involves local importance estimation through significance (or importance) scores assigned to data elements (such as n-grams). In one implementation, end-to-end platform support is provided by way of a graphical user interface, in which an alert is generated when a given data item triggers a data security mechanism (resulting from a positive detection on the data item in the prediction stage), with an indication of an individual data element(s) that has been identified (in the interpretation stage) as ‘significant’ in the sense that it has been determined to have significantly contributed to the positive detection that was obtained in the prediction stage. The following description considers keywords or key ‘tokens’ but the description applies equally to any data item that can be decomposed into individual data elements. The following description considers n-grams of tokens in a sequence, but the description concerning n-grams applies to any ordered sequence of data elements.

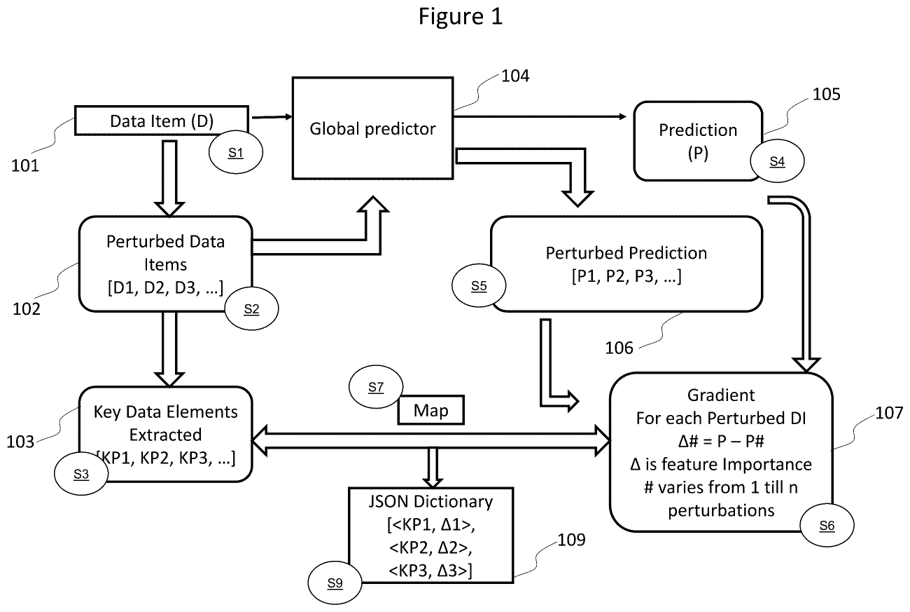

FIG. 1 shows a schematic overview of a two-stage prediction and inference mechanism.

A first layer comprises a global prediction model 104, which predicts if a data item 101 contains specific sensitive information, resulting in a prediction output 105. Various prediction algorithms may be used, such as deep learning algorithms or other machine learning algorithms.

A second layer comprises an interpretation model, which consumes the prediction output 105 of the prediction model 104 along with the original data item 101 as input, and generates a verdict comprising keyword, confidence-score, and location-information. This is based on document perturbation, which is described in more detail below. As described in further detail below, generating the verdict involves generating one or more perturbed data items 102 based on the original data item 101 (by masking data element(s) within the data item), feeding the perturbed data item(s) 102 to the predictor 104, resulting in one or more perturbed prediction outputs 106, and extracting one or more ‘key’ data items 103 (determined to be of relative importance), based on a difference value 107 determined between the (original) prediction 105 and the (or each) perturbed prediction. The difference value 107 is used to measure feature importance (specifically, importance of the data item(s) that were masked in the perturbed data item).

For example, the verdict may be provided in the form of an interpretation output 109, such as a JSON output. The interpretation output 109 may, in some embodiments, be an aggregated output, which aggregated feature importance over multiple data items to which the techniques are applied. An example JSON schema is given below:

{“minTokensInPhrase”:“2”,
“maxTokensInPhrase”:“5”,
“threshold”:“0.0”,
“phraseMap”: {“hello u”: 1.0, “hello world”: 1.0,...}}

### Definitions

minTokensInPhrase −> A minimum count of tokens found in a phrase
maxTokensInPhrase −> A maximum count of tokens found in a phrase
threshold −> A minimum value above which PhraseMap token values are considered for
highlight in a document given.
phraseMap −> Dictionary containing all the phrases extracted from the training
samples with the feature importance scores derived from Global Interpret
methodology.

In the following examples, multiple data elements are considered per data item. Specifically, all unique n-grams within a given data item are considered with n ranging from 1 to a predetermined threshold. For example, with the threshold set to six, all unique n-grams are considered for n=1, . . . , 6. An n-gram refers to a single token (n=1, or ‘unigram’) or a sequence of consecutive tokens (n>1). A unigram might, for example, correspond to a single keyword, whilst a longer n-gram might correspond to a key phrase. Note that, for a key phrase with n=2, the significance of the key phrase as a whole is considered (in the n=2 evaluation), and the significance of the two individual elements are also separately considered (in the n=1 evaluation). A significance score is therefore assigned to the key phrase of two tokens, and significance scores are additionally assigned to each of the tokens individually. This applies to n>2, where a significance score is assigned to the phrase of length n>2, but also its individual components of length n less than or equal to 2.

The process of generating a verdict consumes extract all the relevant tokens and combination of tokens (n-grams) along with assigned weights or coefficients from the prediction model.

A computation of average feature importance across a set of multiple data items may be computed. The method has been demonstrated to estimate feature importance faster than conventional methods (in the sense of requiring fewer computing resources).

To generate the interpretation output 109, in one example, the inputs are the prediction model 104 and a set of training data items (such as documents) which are used to train the prediction model 104. In another example, the interpretation techniques are applied to non-training documents, which have not been used to train the predictor 104. The prediction model 104 may be represented in a file, which contains a training methodology and input parameters which are used for building the prediction model. The interpretation output 109 is created by running an interpretation algorithm which consumes the inputs to extract relevant data items (e.g., n-grams, which are relevant tokens and phrases) and assign weights to unique data items based on feature importance scores computed from the prediction model file.

The weights are computed as average feature importance of a given data element (e.g, word or phrase) available across a set of documents from training samples by the prediction model. Weights can be similar assigned to data elements extracted from data items that were not used in training.

FIG. 1 additionally involves high-level steps involved in the processing of data items, denoted S1 to S8.

S1: the global predictor 104 is trained based on a document 101 or a set of training documents. Input text can be converted to numeric data which is fed to the mathematical ML algorithm. The values or scores generated at the end of training method would be the coefficients of the tokens processed.

These tokens range from single word tokens aka unigrams, 2-word tokens aka bigrams till n grams. The value of n can be chosen, for example, based on the training process and the prediction model 104.

S2: One or more perturbed documents 102 are generated (within a local neighborhood of the original document in feature space) from the input document(s).

A perturbed document may be generated from a given document as follows (in this example, a unigram is masked by removing all instances of that unigram from the document):

Remove one unigram from the document D
This is a perturbed document D#
Run the model on D# and look at the confidence.
Repeat 1 and 2 for all unique unigrams in the document
Repeat 1 and 2 for bigrams, trigrams, 4 grams, 5 grams, 6grams etc till
n grams.
Collect (S3) all ngrams from {1, 2, 3, 4, 5, 6} and store them as
keyphrases

The perturbed document can, in turn, be used to estimate importance of the masked (in this case, removed) unigram in the following manner. The original document 101 and the perturbed document(s) 102 are each fed to the global predictor 104, at S4 and S5 respectively. The result of S4 is a global prediction output 105 (e.g., classification) for the original document 101 that includes a confidence score (referred to as an original prediction and original confidence score). The result of S5 is a global prediction output 106 (e.g., classification) for each perturbed document, which also includes a confidence score (referred to as a perturbed prediction and perturbed confidence score respectively). A difference value 107 (or ‘gradient’) between the original confidence score and the perturbed confidence score is determined at step S6. Step S6 is repeated for each perturbed document, in the case of multiple perturbed documents. Each n-gram extracted at step S3 corresponds to a perturbed document (in which that n-gram is masked). A mapping is stored (S7) between each n-gram extracted at step S3 and the difference value 107 of the corresponding perturbed document as generated in step S6.

Steps S1-S7 may be repeated over multiple data items (each of which is perturbed one or more times to assess significance of one or more n-grams), and the results may be aggregated at step S9.

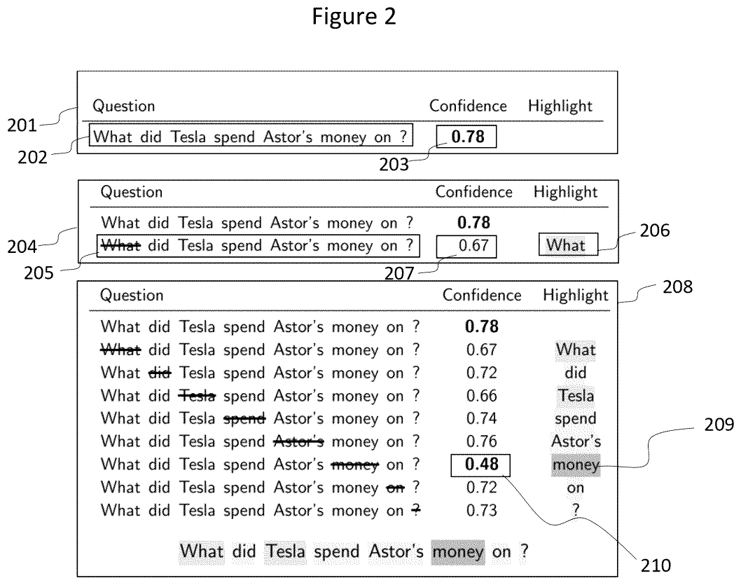

FIG. 2 shows an example where the confidence score and perturbed confidence scores are computed for the data item 202: “What did Tesla spend Astor's money on?”. In Step 201, the confidence sore 203 for data item 202 is computed and is 0.78. In Step 204, a perturbed data item 205 is obtained by removing the data element 206 (“What”) from data item 202. The confidence score 207 for the perturbed data item 205 is computed and is 0.67. The drop in prediction when a data element or feature is removed from the data item may be referred to as feature importance aka weight score. In step 208, the confidence scores are computed for all the data elements (or features) in the data item 202. In the table in Step 208, the words in the “Highlight” column are those which impact the global prediction confidence score when removed from the sentence, thus gaining a weight or numerical importance attributed to the prediction. These words are considered as key words. It can be seen that the data element 209 (“money”) has the highest confidence score 210, which is 0.48.

A similar extension is done for phrases where there are combinations of bigrams, trigrams, etc. This involves repeating the step in FIG. 2 for all n grams to estimate feature importance for all values of n that are considered, e.g., bigrams, trigrams etc.

### Example Extension

The above techniques could, among other things, be used to generate training data for training a ‘self-interpretation model. Such a model may be incorporated into a global classifier to equip the global classifier with self-interpretation logic.

### Self Interpretation Models

Training data for self-interpretation is generated either using the technique described above or a ‘gradient weight’ approach in the case of deep learning models. This can be done in a self-supervised way where annotated data is not required. The output of a Large Language Model (LLM) deep learning (DL) model is a probability output. Assuming that the expected output is positive, the weight contribution of each of the tokens is computed using one step of gradient descent. Since each token input is an embedding vector, each gradient vector needs to be collapsed and normalized into a single contribution value. An example of such a metric is called a saliency map but there are many variations on the same idea. For example, it is possible to use the angle between the embedding and the corresponding gradient. This technique is better suited for training DL models since it does not have the training limitations of the technique described above which is trained on a limited annotated set that might not cover the real space very well.

There are two main advantages of self-interpretation models over gradient interpretations: the computing cost is roughly halved, and the interpretation is a span representation instead of individual words which do not carry enough meaning for the end user. Self-interpretation models also improve classification robustness.

A trainable self-interpretation model is described below, together with a training methodology.

A predetermined interpretation process is used to generate training data for training the self-interpretation model. A training set may comprise training items (e.g., document), where each training item is associated with a groundtruth classification output (e.g., classification confidence score or scores) and additionally an interpretation ground truth. In the following examples, the interpretation of truth comprises a set of training elements belonging to or otherwise related to the training item (e.g., tokens, which may for example represent words or phrases), and an individual importance score for each training element. For a given training item, the set of training elements may comprise a first training element associated with a first groundtruth importance score and a second training element associated with a second groundtruth importance score, where the first and second individual importance groundtruth denote importance of the first and second training elements respectively to the groundtruth classification output. The set of training elements may comprise more than two training elements in some cases, which are similarly scored.

In a first embodiment, the interpretation process uses the techniques described above to individually score the training elements of the interpretation ground truth for each training item. In another embodiment, an alternative approach is used to individually score the training elements, such as a gradient weight process or other existing interpretation process. In a third embodiment, training data items are manually annotated to mark or score salient element(s). Two or more of these methods could be used to generate mixed training data consisting, for example, of both gradients and manually annotated data. Because gradients do not need manual intervention, a very large number of them can be computed and used, for example, in a pretraining of the interpretation outputs. However, these gradients do not provide the desired interpretation type, which is a continuous subset of the input (or span). Therefore, manual data can be used, for example, after pretraining the model with gradients, for fine tuning the model to give as output a continuous interpretative subset of the input.

Importance indicators assigned to elements of a data item can take various form, such as a per-item importance score, or section markers defining one or more salient sections (subsequences) of data item comprising a sequence of elements.

The interpretation process may be relatively slow to implement and require a relatively large amount of computer resources. With the present approach, the interpretation process need only be used once, to generate training data for training the self-interpretation model. Once trained, the self-interpretation model can be executed quickly at runtime on a given item using relatively few computer resources. Therefore, the present approach provides a classification interpretation function in a more computationally efficiency manner.

A classifier has the form of a trainable machine learning (ML) model (e.g, neural network), which is configured to generate for each training item a predicted classification output corresponding in form to the groundtruth classification output. The classifier is trained based on a classification loss function that quantifies error between the predicted classification output and the groundtruth classification output. This results in a trained classifier than can generate a predicted classification output (e.g, overall score or scores) for an input item not encountered during training.

A self-interpretation model has the form of a trainable ML model, such as a neural network. The self-interpretation model is configured to generate from a given training item an interpretation output corresponding in form to the interpretation groundtruth. For example, the interpretation output may comprise a first predicted importance score associated with the first training element of the training item and a second predicted importance score associated with the second training element of the training item. In training, a self-interpretation loss function is defined, which quantifies error between the interpretation output for each training item and the interpretation ground truth for that training item. Parameters (e.g, weights) of the self-interpretation model are tuned based interpretation loss function, e.g, by tuning the parameters based on a gradient of the self-interpretation loss function with respect to each parameter. Once trained, the self-interpretation model can be applied to an input item not encountered in training, to compute a comparable interpretation output, e.g, comprising a first predicted importance score for a first element of the input item and a second predicted importance score for a second element of the input item. The predicted importance scores denoted predicted importance of those elements to the classification output generated by the trained classifier.

Using manual annotations of class and saliency, a classier and self-interpretation model can be trained jointly. In other cases, were saliency scores are extracted from a trained classifier, training is in two stages. The first training stage is classifier training. A saliency analysis is performed on the trained classifier to generate saliency GT. Then, the second training stage, self-interpretation training is performed.

In some implementations, the self-interpretation model and a classifier may share feature extraction layers.

In other implementations, the classifier and self-interpretation model are trained separately. For example, the classifier may be trained initially, and the trained classifier may be used to generate the training data for the self-interpretation model (e.g, using the highlighting techniques described above).

In some such implementations, the self-interpretation model is trained together with the classifier in an end-to-end fashion, based on an overall loss function that incorporates the classification loss function and the self-interpretation loss function (e.g, as separate terms of the overall loss function).

It is noted in this respect that a neural network may be sub-network within a larger neural network.

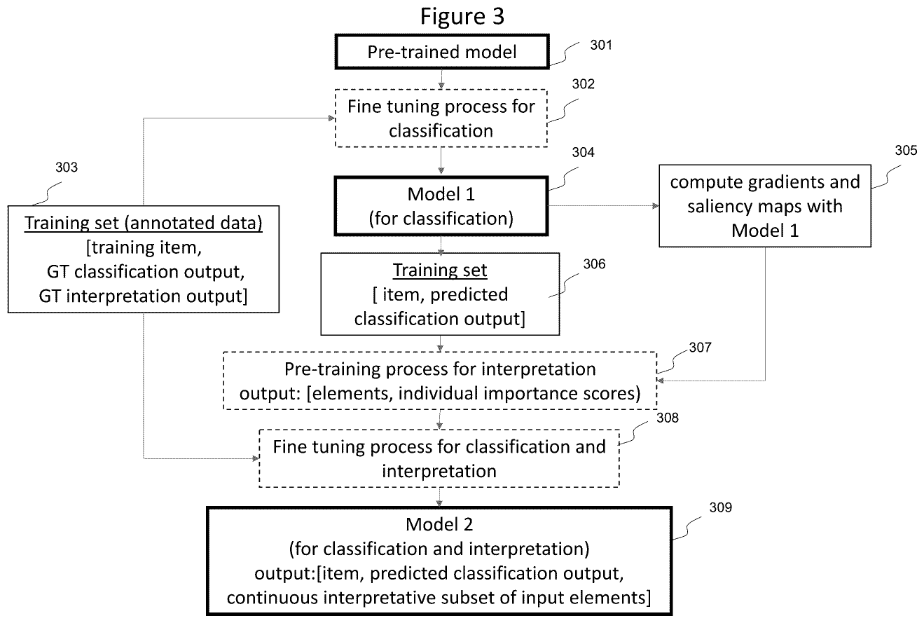

FIG. 3 shows an example method for training a self-interpretation model 309. Training set 303 comprises annotated training items, where each training item is associated with a groundtruth (GT) classification output and a GT interpretation output. Training set 303 is used to fine tune the pre-trained model 301, in a fine-tuning process 302, to give a model 304 trained for classification, Model 1. For every input item, Model 1 produces an output comprising of the item and its predicted classification output. These pairs, form training set 306, which is used as training data for training a self-interpretation model. In Step 305, gradients and saliency maps are computed from Model 1 and are used in the pre-training interpretation Step 307. The gradient computation does not require manual intervention, and thus a very large number of gradients can be computed and used in the pre-training of Step 307. For every training item, the pre-trained interpretation model outputs elements of the input item with their individual importance scores. For interpretation purposes, it is often desirable to have a continuous sequence of training elements as output. For this reason, manually annotated data can be used in a fine tuning process 308. Training set 303 is used in a fine tuning process 308 for both classification and interpretation, giving the self-interpretation model 309, Model 2. The output can be forced to be a continuous sequence by switching from probability vectors to beginning-and-end vectors (span representation). An example of span encoding is span_extractor—AllenNLP v2.10.1. Model 2 can be applied to an input item not encountered in training to give an overall classification output for the item, together with elements of the input item with their individual importance scores, and a continuous subset of input elements for interpretation.

Model interpretation is an important feature for any user-facing machine learning system, as users want to understand why models made the decision that they have. An innovative way of performing model interpretation is described.

A model is architected and trained to output an explanation along with a classification/prediction result, regardless of the complexity of the model.

For conventional linear models, an explanation might alternatively be obtained as a computable ‘invert function’. For example, with a decision tree, the invert function returns a list of branching that led to a decision. However, for more complex models, especially deep learning models, there is no such simple explanation, as these lack any readily computable invert function. The techniques described herein are particularly useful for models that are inherently ‘unexplainable’.

State of the art deep learning models have a lot of parameters and redundancy that can be exploited to perform multiway classification. The described method leverages this property in a new way by training these complex models to output the interpretation along the classification decision.

Formally a typical categorization system will have a vector yc as output for each class it aims to classify and vector x as an input. An interpretation model will aim to output the weight contribution of each feature in x for each category which results in an explanation matrix xe of dimension (sizeof(x), sizeof(yc)).

A typical LLM has an input space which is a matrix of size (n, d) where n is the number of tokens, and d is the embedding size. Thus, the data item is inputted to the LLM as a sequence of n tokens or vectors. The output is a sequence of length n, where position i in the output sequence is the score for token i in the input sequence. Typically for classification, special tokens are added at the beginning and end, resulting in an effective (n+2, d) matrix size. The output will be of dimension (n+2, h) where h is the hidden size. The value of h can be chosen to be equal or not to the embedding size. In a classification setting, a classification head is added that will map the first output corresponding to the start special token to a binary classification probability. This leaves n+1 outputs which that are typically used for word prediction. For self-interpretation the next n outputs dim(n, h) will be mapped to an interpretation vector with dimension (n, 1) of probabilities of contribution to the decision. The classification head and interpretation head have their own separate loss function; training can be achieved using one or both of the loss functions at the same time. The first loss function is a supervised classification function e.g., a logistic loss. The second loss function can be the MSE between the interpretability head output and the expected interpretability probability given by the saliency map described above, the technique described previously or a combination.

State of the art deep learning model structure is such that, from an intermediate state (called intermediate embedding), all category decisions are computed using a decision model which could, for example, be a softmax model, or a more complex model. In the case of the present self-explainable model, a new branching model is added from the embedding layer that will produce the xe matrix, called the self-explainable module.

In a supervised or self-supervised setting, data is required to train the model. Here, training data can be generated using any of the existing interpretation models or a combination of them. An appropriate loss function can be added as the training criteria for the explanations. For example, the mean squared error between the prediction explanation and the expected one, can be used as loss function.

The model can be trained from scratch, or any pretrained checkpoint can be leveraged before the self-explainable module is added, followed by fine-tuning. Thus, starting from an LLM checkpoint, a self-supervised step can be performed for learning the interpretation output using non annotated data, before fine tuning on the classification data. The model can have a multi-step training setting where after pretraining and category fine-tuning, an additional interpretation fine-tuning step is performed. A pre-trained self-explainable model can also be used, where the self-explainable module is added both in the pre-training and fine-tuning steps. The advantage of this is to ensure that during pre-training, embeddings contain the necessary information for explanation, resulting in shorter fine-tuning steps.

There are several advantages of a self-explainable model. Interpretation systems typically are in two steps namely, the model performs a prediction, then an interpretation process is used to explain the result. There are many methods of interpretation that can be used, and in the literature, they fall into 2 categories: black box methods, that do not make any assumption on the underlying model, and white box methods that exploit properties of the models to explain the decision. Examples of black box methods include “lime”, “shap” and any approximation done by an explainable model like linear or simple tree models. Black box local interpretation is based on generating explanations local to the document. The technique used mostly is approximating a linear function to a prediction model. Although this method does not include lot of complications in generating explanations, however the weights or importance scores arrived are approximated on linear approach which may not represent the exact model inferences. Implementing local interpretation for each document predicted positive is costly and COGS heavy in runtime. Examples of white box methods include saliency maps using backpropagation, attention maps for attention-based models. The core idea with white box interpretation is that by computing the loss with respect to the expected answer, applying backpropagation, the gradients in the embedding layer will reflect the positive or negative importance of a particular token. Since one token embedding is a vector, some form of normalization needs to happen on top of the gradients to produce an average single number for each token. Hybrid interpretation is a combination of both global and local interpretation processes.

The core idea of the one-step self-explainable model method is that the model will output its explanation at the same time as the classification result. So, although closer to the white box interpretation process, the present method belongs in its own category as it is achieved in one step instead of the 2 steps needed in existing interpretation systems. The advantage of this self-explainable method over existing ones is that it is less complex than a two-step method, resulting in simpler engineering design that save development time and maintenance. Further, it saves “cogs” (containers for machine learning models), since the explanation will come with a very small increase in computation compared to original predicting model, all in one inference. As a comparison, lime and shap in estimating their approximation, need 10 s of separate inferences resulting in a number of COGS which is an order of magnitude more expensive. Saliency maps while more efficient than black box methods, still need a backpropagation step which results in roughly twice the cost. A further advantage of this one-step self-explainable method is that it improves the classification results slightly by forcing the model to take account explanations in its decision.

### Graphical User Interface

Organisations may be required to view; assess and enforce compliance policies for critical, confidential and sensitive documents stored over various workloads. Data security mechanism may also be used, for example, to restrict certain activities in respect of data items identified as ‘offensive’ (e.g., containing excessive profanity, or threatening content). These documents can belong to a vast variety of functions including finance, HR, sales, legal, operations, production. The number of documents classified is huge for certain classifiers and it is difficult to test each document. There is a need for a mechanism where the model also depicts on what basis/keywords/features is the document classified. Users of the model have a need for transparency about reasons for classifying document under any model. This will help bring trust in users for model performance and they will be confident while utilizing these classifiers for creating DLP, sensitivity and retention policies.

A graphical user interface (GUI) can be programmed to have highlighting features as a visual tool. The highlighting capability would indicate which words/phrases in a document triggered the global classifier match. A confidence level with the models used may also be displayed e.g., as “high”, “medium” or “low” confidence. The confidence level can be shown on the UI for the highlighted keyword. On mouseover of highlighted keywords, the classifier name is displayed to give users insight on which classifier was triggered. As explained above, classifiers can detect single or multiple categories for which a particular content is processed for which can range from detecting offensive language like threat, harassment, etc, to business category detection. A threshold could be set for every classifier to trigger a positive detection. A second threshold may be applied to the local confidence scores to select relevant keyword(s)/data element(s) contributing to the positive detection (e.g., to enable those keyword(s) to be visually highlighted, redacted from the data item etc.). As such, the GUI can display “alerts”. An alert is generated when a given data item triggers a data security mechanism (resulting from a positive detection on the data item in the prediction stage), with an indication of an individual data element(s) that has been identified (in the interpretation stage) as ‘significant’ in the sense that it has been determined to have significantly contributed to the positive detection that was obtained in the prediction stage. This is shown in the example GUI below where an alert is generated (by a positive detection) for a profanity threat and relevant keywords (examples of sensitive information categories) in the document are visually highlighted within the GUI.

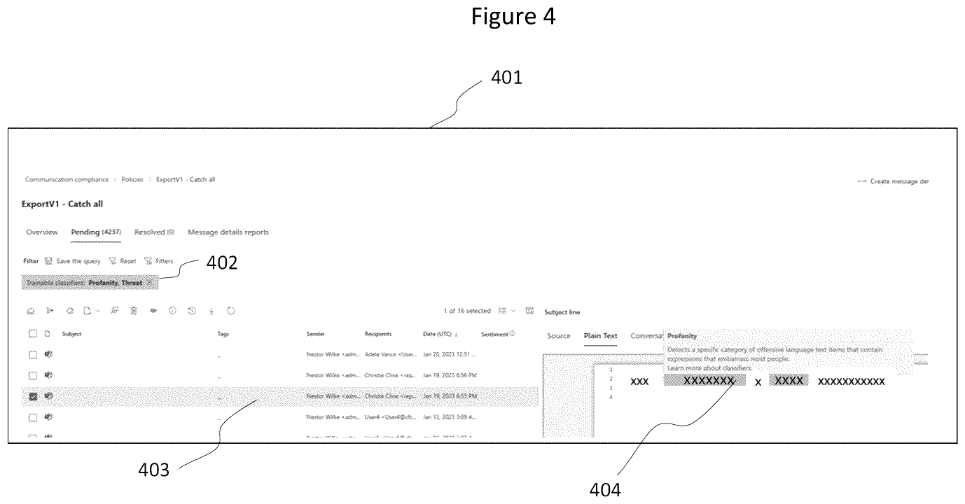

FIG. 4 shows an example view 401 within a GUI, in which a list of alerts is displayed. An alert might, for example, correspond to a positive detection that has triggered some data security mechanism. The depicted example considers ‘threat’ and ‘profanity’ detections (denoted by element 402). An alert 403 is selected within the GUI, resulting in one or more data item 404 that have been identified as important being visually highlighted.

The described highlighting feature could alternatively or additionally be used to store words/phrases (for every classifier) whose coefficient exceeds the classifier's threshold to trigger. These words/phrases can be shown as highlighted content. For example, the feature could store the top 3 words/phrases per classifier. For example, if a matched keyword is repeated in the document, then a maximum (e.g., up to 10) of such instances will be identified and returned in interpretation results.

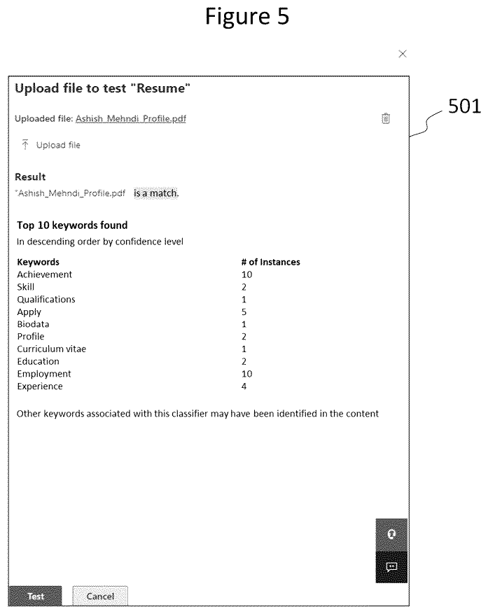

FIG. 5 shows an example of an aggregated output 501 that may be generated by aggregating feature importance estimates over multiple data items. In this example, the aggregate output 501 lists the ten most important keywords identified over a set of documents in respect of a given global predictor.

The use of the highlighting feature could provide information to improve the feature such as: the number of clicks on the “view message details” action or corresponding action where classifier name that matched message is shown, speed of remediation for policy matches, number of cross tenant feedback provided, number of escalations regarding this type of classification.

### Cloud Infrastructure

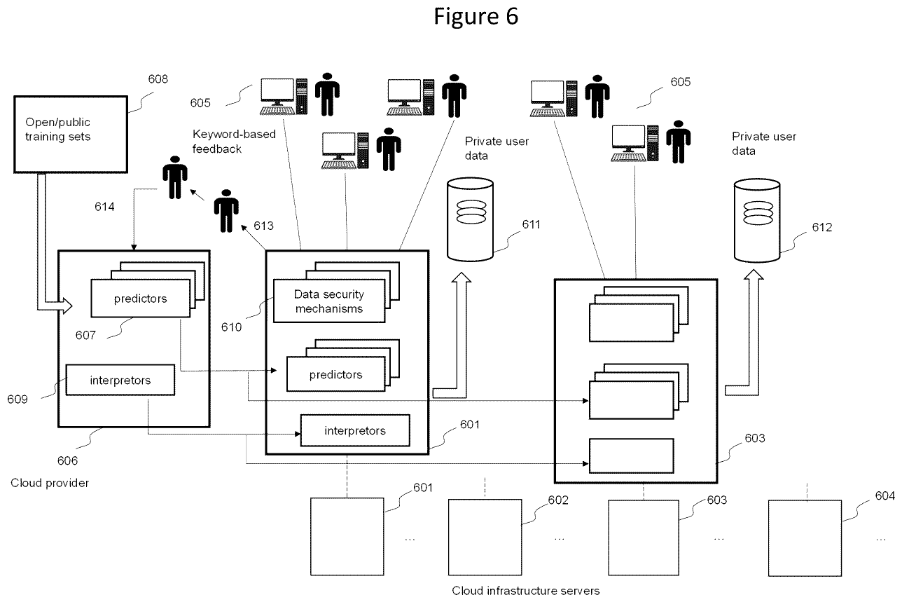

FIG. 6 shows a set of cloud infrastructure (servers) 601-604 supporting multiple user groups (such as customers) 605, with a cloud provider 606 who provides predictors 607 trained on open/public datasets 608. These predictors are deployed to customer infrastructure, with corresponding interpreters 609. Predictors are used within each user groups' 605 cloud infrastructure 601, 603 at runtime to implement data security mechanisms 610 (runtime deployment) on their private data (retained within their sub-system) 611-612.

Each user group provide keyword-based feedback 613 to the cloud provider 606 which is used for re-training/predictor refinement 614, without releasing private customer data 611-612.

In this context, a customer-specific GUI may be provided, with a customer-specific authentication mechanism. This enables a customer to explore predictions and interpretation results pertaining to their own private data, and generate aggregate keyword-based feedback to the cloud provider, without granting the cloud provider access to their private data.

The deployment model of FIG. 6 enables the provider to train predictors with ‘outbox’ (e.g., public/open) data initially. Customers can, in turn, review the predictors outputs (generated within their own infrastructure) efficiently since features that impact model predictions are automatically highlighted. The highlighted features can then be fed back to the provider, to assist in re-training and/or other tuning or refinement of the predictors.

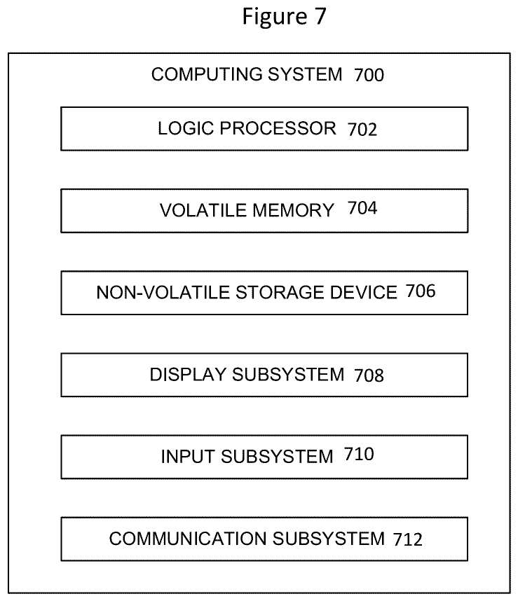

FIG. 7 schematically shows a non-limiting example of a computing system 700, such as a computing device or system of connected computing devices, that can enact one or more of the methods or processes described above, including the filtering of data and implementation of the structured knowledge base described above. Computing system 700 is shown in simplified form. Computing system 700 includes a logic processor 702, volatile memory 704, and a non-volatile storage device 706. Computing system 700 may optionally include a display subsystem 708, input subsystem 710, communication subsystem 712, and/or other components not shown in FIG. 7. Logic processor 702 comprises one or more physical (hardware) processors configured to carry out processing operations. For example, the logic processor 702 may be configured to execute instructions that are part of one or more applications, programs, routines, libraries, objects, components, data structures, or other logical constructs. The logic processor 702 may include one or more hardware processors configured to execute software instructions based on an instruction set architecture, such as a central processing unit (CPU), graphical processing unit (GPU) or other form of accelerator processor. Additionally or alternatively, the logic processor 702 may include a hardware processor(s)) in the form of a logic circuit or firmware device configured to execute hardware-implemented logic (programmable or non-programmable) or firmware instructions. Processor(s) of the logic processor 702 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor 702 may be virtualized and executed by remotely accessible, networked computing devices configured in a cloud-computing configuration. In such a case, these virtualized aspects are run on different physical logic processors of various different machines. Non-volatile storage device 706 includes one or more physical devices configured to hold instructions executable by the logic processor 702 to implement the methods and processes described herein. When such methods and processes are implemented, the state of non-volatile storage device 706 may be transformed—e.g., to hold different data. Non-volatile storage device 706 may include physical devices that are removable and/or built-in. Non-volatile storage device 706 may include optical memory (e g., CD, DVD, HD-DVD, Blu-Ray Disc, etc.), semiconductor memory (e g., ROM, EPROM, EEPROM, FLASH memory, etc.), and/or magnetic memory (e.g., hard-disk drive), or other mass storage device technology. Non-volatile storage device 706 may include nonvolatile, dynamic, static. read/write, read-only, sequential-access, location-addressable, file-addressable, and/or content-addressable devices. Volatile memory 704 may include one or more physical devices that include random access memory. Volatile memory 704 is typically utilized by logic processor 702 to temporarily store information during processing of software instructions. Aspects of logic processor 702, volatile memory 704, and non-volatile storage device 706 may be integrated together into one or more hardware-logic components. Such hardware-logic components may include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example. The terms “module,” “program,” and “engine” may be used to describe an aspect of computing system 700 typically implemented in software by a processor to perform a particular function using portions of volatile memory, which function involves transformative processing that specially configures the processor to perform the function. Thus, a module, program, or engine may be instantiated via logic processor 702 executing instructions held by non-volatile storage device 706, using portions of volatile memory 704. Different modules, programs, and/or engines may be instantiated from the same application, service, code block, object, library, routine. API, function, etc. Likewise, the same module, program, and/or engine may be instantiated by different applications, services. code blocks, objects, routines. APIs, functions, etc. The terms “module,” “program,” and “engine” may encompass individual or groups of executable files, data files, libraries, drivers, scripts, database records, etc. When included, display subsystem 708 may be used to present a visual representation of data held by non-volatile storage device 706. The visual representation may take the form of a graphical user interface (GUI). As the herein-described methods and processes change the data held by the non-volatile storage device, and thus transform the state of the non-volatile storage device, the state of display subsystem 708 may likewise be transformed to visually represent changes in the underlying data. Display subsystem 708 may include one or more display devices utilizing virtually any type of technology. Such display devices may be combined with logic processor 702, volatile memory 704, and/or non-volatile storage device 706 in a shared enclosure, or such display devices may be peripheral display devices. When included, input subsystem 710 may comprise or interface with one or more user-input devices such as a keyboard, mouse, touch screen, or game controller. In some embodiments, the input subsystem may comprise or interface with selected natural user input (NUI) componentry. Such componentry may be integrated or peripheral, and the transduction and/or processing of input actions may be handled on-or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor. When included, communication subsystem 712 may be configured to communicatively couple various computing devices described herein with each other, and with other devices. Communication subsystem 712 may include wired and/or wireless communication devices compatible with one or more different communication protocols. As non-limiting examples, the communication subsystem may be configured for communication via a wireless telephone network, or a wired or wireless local-or wide-area network. In some embodiments, the communication subsystem may allow computing system 700 to send and/or receive messages to and/or from other devices via a network such as the internet. The term computer readable media as used herein may include computer storage media. Computer storage media may include volatile and non-volatile, removable and nonremovable media (e.g., volatile memory 704 or non-volatile storage 706) implemented in any method or technology for storage of information, such as computer readable instructions, data structures, or program modules. Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g, the computing system 700 or a component device thereof). Computer storage media does not include a carrier wave or other propagated or modulated data signal. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct wired connection, and wireless media such as acoustic, radio frequency (RF), infrared, and other wireless media.

A first aspect herein provides a computer system comprising: at least one memory configured to store computer-readable instructions; and at least one hardware processor coupled to the at least one memory, and configured to execute the computer-readable instructions, which upon execution cause the at least one hardware processor to implement operations comprising: receiving a data item; inputting the data item to a machine learning (ML) predictor, resulting in a prediction pertaining to the data item as a whole, and a confidence score pertaining to the prediction; masking a data element in the data item, resulting in a perturbed data item; inputting the perturbed data item to the ML predictor, resulting in a perturbed prediction pertaining to the data item as a whole, and a perturbed confidence score pertaining to the prediction; assigning to the data element, based on the confidence score and the perturbed confidence score, a significance score denoting significance of the data element to the prediction; and performing a data security action based on the significance score assigned to the data element.

In embodiments, said operations may comprise: training or re-training the ML predictor based on the significance score, resulting in an updated ML predictor, wherein the data security action is performed using the updated ML predictor.

The data security action may be performed on a second data item using the updated ML predictor applied to the second data item.

The data security action may comprise blocking access, release, exchange, modification, destruction, disruption or use of the second data item.

The data security action may be performed on the data item based on the prediction and the significance score.

The data security action may comprise via a graphic user interface an alert indicating the data item and the data element.

The data security action may additionally comprise blocking access, release, exchange, modification, destruction, disruption or use of the data item.

The data element may be redacted from the data item based on the significance score, responsive to an upload or download action attempted on the data item.

A second aspect herein provides a computer-implemented method, comprising: receiving a training item and a groundtruth classification output associated with the training item; determining using an interpretation process a first groundtruth importance indicator associated with a first training element of each training item, the first groundtruth importance indicator denoting importance of the first training element to the groundtruth classification output, and a second groundtruth importance indicator associated with a second training element of each training item, the second groundtruth importance indicator denoting importance of the second training element to the groundtruth classification output; and training a self-interpretation model based on the training item, the first groundtruth importance indicator and the second groundtruth importance indicator, resulting in a trained self-interpretation model configured to compute from an input item a first predicted importance indicator associated with a first element of the input item and a second predicted importance indicator associated with a second element of the input item.

In embodiments, the interpretation process may comprise: training a classifier based on the training item and the groundtruth classification output, resulting in a trained classifier configured to generate from the input item a predicted classification output, the first predicted importance indicator and the second predicted importance indicator each relating to the predicted classification output.

The method may comprise: receiving an input item; generating using the trained classifier applied to the input item a predicted classification output; and computing using the trained self-interpretation model applied to the input item a first predicted importance indicator associated with a first element of the input item, the first predicted importance indicator denoting importance of a first training element of the input item, and a second predicted importance indicator associated with a second element of the input item, the second predicted importance indicator denoting importance of a second element of the input item to the predicted classification output.

The method may comprise performing a data security action based on the predicted classification output, the first predicted importance indicator and the second predicted importance indicator.

The interpretation process may comprise a gradient weight process.

The importance indicator may be an importance score or section marker.

A third aspect herein provides a computer-readable storage medium embodying computer-readable instructions, which upon execution on at least one hardware processor, cause the at least one hardware processor to implement operations comprising: receiving a training item; generating using a classifier applied to the training item a predicted classification output; determining using an interpretation process a first groundtruth importance indicator associated with a first training element of each training item, the first groundtruth importance indicator denoting importance of the first training element to the predicted classification output, and a second groundtruth importance indicator associated with a second training element of each training item, the second groundtruth importance indicator denoting importance of the second training element to the predicted classification output; and training a self-interpretation model based on the training item, the first groundtruth importance indicator and the second groundtruth importance indicator, resulting in a trained self-interpretation model configured to compute from an input item a first predicted importance indicator associated with a first element of the input item and a second predicted importance indicator associated with a second element of the input item.

In embodiments, the interpretation process may comprise: training a classifier based on the training item and the groundtruth classification output, resulting in a trained classifier configured to generate from the input item a predicted classification output, the first predicted importance indicator and the second predicted importance indicator each relating to the predicted classification output.

The operations may comprise: receiving an input item; generating using the trained classifier applied to the input item a predicted classification output; and computing using the trained self-interpretation model applied to the input item a first predicted importance indicator associated with a first element of the input item, the first predicted importance indicator denoting importance of a first training element of the input item, and a second predicted importance indicator associated with a second element of the input item, the second predicted importance indicator denoting importance of a second element of the input item to the predicted classification output.

The operations may comprise: performing a data security action based on the predicted classification output, the first predicted importance indicator and the second predicted importance indicator.

The interpretation process comprises a gradient weight process.

The classifier may output a confidence score associated with the predicted classification output, and the interpretation process may comprise: masking the first training element of each training item, resulting in a first perturbed training item; inputting the first perturbed training item to the classifier, resulting in a first perturbed classification output and a first perturbed confidence score; assigning the first significance score to the first training element based on the confidence score and the first perturbed confidence score; masking the second training element of each training item, resulting in a second perturbed training item; inputting the second perturbed training item to the classifier, resulting in a second perturbed classification output and a second perturbed confidence score; assigning the second significance score to the second training element based on the confidence score and the second perturbed confidence score.

It will be appreciated that the above embodiments have been disclosed by way of example only. Other variants or use cases may become apparent to a person skilled in the art once given the disclosure herein. The scope of the present disclosure is not limited by the above-described embodiments, but only by the accompanying claim.

1. A computer system comprising:
at least one memory configured to store computer-readable instructions; and
at least one hardware processor coupled to the at least one memory, and configured to execute the computer-readable instructions, which upon execution cause the at least one hardware processor to implement operations comprising:
receiving a data item;
inputting the data item to a machine learning (ML) predictor, resulting in a prediction pertaining to the data item as a whole, and a confidence score pertaining to the prediction;
masking a data element in the data item, resulting in a perturbed data item;
inputting the perturbed data item to the ML predictor, resulting in a perturbed prediction pertaining to the data item as a whole, and a perturbed confidence score pertaining to the prediction;
assigning to the data element, based on the confidence score and the perturbed confidence score, a significance score denoting significance of the data element to the prediction; and
performing a data security action based on the significance score assigned to the data element.

2. The computer system of claim 1, said operations comprising:
training or re-training the ML predictor based on the significance score, resulting in an updated ML predictor, wherein the data security action is performed using the updated ML predictor.

3. The computer-implemented method of claim 2, wherein the data security action is performed on a second data item using the updated ML predictor applied to the second data item.

4. The computer-implemented method of claim 3, wherein the data security action comprises blocking access, release, exchange, modification, destruction, disruption or use of the second data item.

5. The computer-implemented method of claim 4, wherein the data security action comprises outputting via a graphic user interface an alert indicating the data item and the data element.

6. The computer-implemented method of claim 5, wherein the data security action additionally comprises blocking access, release, exchange, modification, destruction, disruption or use of the data item.

7. The computer-implemented method of claim 1, wherein the data security action is performed on the data item based on the prediction and the significance score.

8. The computer-implemented method of claim 1, comprising redacting the data element from the data item based on the significance score, responsive to an upload or download action attempted on the data item.

9. A computer-implemented method, comprising:
receiving a training item and a groundtruth classification output associated with the training item;
determining using an interpretation process a first groundtruth importance indicator associated with a first training element of each training item, the first groundtruth importance indicator denoting importance of the first training element to the groundtruth classification output, and a second groundtruth importance indicator associated with a second training element of each training item, the second groundtruth importance indicator denoting importance of the second training element to the groundtruth classification output; and
training a self-interpretation model based on the training item, the first groundtruth importance indicator and the second groundtruth importance indicator, resulting in a trained self-interpretation model configured to compute from an input item a first predicted importance indicator associated with a first element of the input item and a second predicted importance indicator associated with a second element of the input item.

10. The method of claim 9, wherein the interpretation process comprises:
training a classifier based on the training item and the groundtruth classification output, resulting in a trained classifier configured to generate from the input item a predicted classification output, the first predicted importance indicator and the second predicted importance indicator each relating to the predicted classification output.

11. The method of claim 10, comprising:
receiving an input item;
generating using the trained classifier applied to the input item a predicted classification output; and
computing using the trained self-interpretation model applied to the input item a first predicted importance indicator associated with a first element of the input item, the first predicted importance indicator denoting importance of a first training element of the input item, and a second predicted importance indicator associated with a second element of the input item, the second predicted importance indicator denoting importance of a second element of the input item to the predicted classification output.

12. The method of claim 11, comprising performing a data security action based on the predicted classification output, the first predicted importance indicator and the second predicted importance indicator.

13. The method of claim 10, wherein the interpretation process comprises a gradient weight process.

14. The method of claim 9, wherein the importance indicator is an importance score or section marker.

15. A computer-readable storage medium embodying computer-readable instructions, which upon execution on at least one hardware processor, cause the at least one hardware processor to implement operations comprising:
receiving a training item;
generating using a classifier applied to the training item a predicted classification output;
determining using an interpretation process a first groundtruth importance indicator associated with a first training element of each training item, the first groundtruth importance indicator denoting importance of the first training element to the predicted classification output, and a second groundtruth importance indicator associated with a second training element of each training item, the second groundtruth importance indicator denoting importance of the second training element to the predicted classification output; and
training a self-interpretation model based on the training item, the first groundtruth importance indicator and the second groundtruth importance indicator, resulting in a trained self-interpretation model configured to compute from an input item a first predicted importance indicator associated with a first element of the input item and a second predicted importance indicator associated with a second element of the input item.

16. The computer-readable storage medium of claim 15, wherein the interpretation process comprises:
training a classifier based on the training item and the groundtruth classification output, resulting in a trained classifier configured to generate from the input item a predicted classification output, the first predicted importance indicator and the second predicted importance indicator each relating to the predicted classification output.

17. The computer-readable storage medium of claim 16, the operations comprising:
receiving an input item;
generating using the trained classifier applied to the input item a predicted classification output; and
computing using the trained self-interpretation model applied to the input item a first predicted importance indicator associated with a first element of the input item, the first predicted importance indicator denoting importance of a first training element of the input item, and a second predicted importance indicator associated with a second element of the input item, the second predicted importance indicator denoting importance of a second element of the input item to the predicted classification output.

18. The computer-readable storage medium of claim 17, the operations comprising performing a data security action based on the predicted classification output, the first predicted importance indicator and the second predicted importance indicator.

19. The computer-readable storage medium of claim 18, wherein the interpretation process comprises a gradient weight process.

20. The computer-readable storage medium of claim 15, wherein the classifier outputs a confidence score associated with the predicted classification output, and the interpretation process comprises:
masking the first training element of each training item, resulting in a first perturbed training item;
inputting the first perturbed training item to the classifier, resulting in a first perturbed classification output and a first perturbed confidence score;
assigning the first significance score to the first training element based on the confidence score and the first perturbed confidence score;
masking the second training element of each training item, resulting in a second perturbed training item;
inputting the second perturbed training item to the classifier, resulting in a second perturbed classification output and a second perturbed confidence score;
assigning the second significance score to the second training element based on the confidence score and the second perturbed confidence score.
